(19) United States
(12) Patent Application Publication
(10) Pub. No.: US 2026/0031689 A1
(43) Pub. Date: Jan. 29, 2026

(54) METHOD AND DEVICE FOR FOLDING A SLOT INSULATION AND USES THEREOF

(71) Applicant: GROB-WERKE GmbH & Co. KG, MINDELHEIM (DE)

(72) Inventors: Manfred ZIEGLER, HILTENFINGEN (DE); Markus SCHMÖLZ, RIEDEN (DE)

(21) Appl. No.: 19/280,261

(22) Filed: Jul. 25, 2025

(30) Foreign Application Priority Data
Jul. 26, 2024 (DE) 102024002446.8
May 8, 2025 (EP) 25175161.6

(51) Int. Cl. H02K 15/106; B23P 19/02

(52) U.S. Cl. CPC H02K 15/106; B23P 19/02

(57) ABSTRACT

A method for folding insulation by providing a component of an electrical machine with a slot extending in the axial direction of the component, with conductors inserted into the slot to form a coil winding and with the insulation inserted into the slot between the slot and the conductors for electrically insulating the conductors from the slot, the insulation with a first and second legs. In at least leg, a longitudinal edge region protrudes radially over the conductors and projects out of the slot in an axial direction. The method includes pre-positioning the part projecting axially out of the slot and protruding over the conductors by moving it towards the center of the slot to create a gap between the longitudinal edge region and the slot flanks and inserting a folding tool into the gap and folding over the longitudinal edge region towards the conductors with the folding tool.

### CROSS-REFERENCES TO RELATED APPLICATIONS

This application claims the benefit of German Patent Application Number 10 2024 002 446.8 filed on Jul. 26, 2024 and European Patent Application Number 25 175 161.6 filed on May 8, 2025, the entire disclosures of which are incorporated herein by way of reference.

### FIELD OF THE INVENTION

The invention relates to a folding method for folding a slot insulation which is inserted into a slot extending in the axial direction of a component of an electrical machine in order to electrically insulate conductors inserted into the slot to form a coil winding from the regions of the component forming the slot. The invention further relates to a slot cover slide mounting method for mounting a slot cover slide in a slot provided with conductors and slot insulation of a component of an electrical machine by performing such a folding method. The invention further relates to a folding device for folding a slot insulation inserted into a slot extending in the axial direction of a component of an electrical machine in order to electrically insulate conductors inserted into the slot to form a coil winding from the regions of the component forming the slot. The invention further relates to a slot cover slide mounting apparatus and a manufacturing system for a stator (example of the component of the electrical machine) comprising such a folding device. The invention further relates to a control unit and a computer program with instructions for the aforementioned device, apparatus or system for carrying out one of the aforementioned methods.

### BACKGROUND OF THE INVENTION

For the technological background and prior art, reference is made to the following literature:
[1] EP 3 724 970 B1
[2] EP 4 203 262 A1
[3] EP 3 391 512 B1
[4] DE 10 2017 101 381 A1
[5] DE 1 203 375 A
[6] DE 10 2017 002 420 A1
[7] DE 10 2016 113 898 A1
[8] U.S. Pat. No. 1,557,259 A
[9] U.S. Pat. No. 1,501,510 A
[10] EP 4 283 846 B1
[11] EP 3 743 986 B1
[12] https://de.wikipedia.org/wiki/Hairpin-Technologie
[13] EP 3 391 516 B1
[14] WO 2019/166060 A1
[15] WO 2020/187 363 A1
[16] WO 2019/101 272 A1
[17] WO 2019/020 148 A1
[18] WO 2018/233 771 A1

In [1], methods and devices for producing slot insulations for winding slots of a component of an electrical machine and a manufacturing system for a stator are disclosed which can also be used in embodiments of the invention. [2] shows a further example of a component of an electrical machine with slot insulations.

[3] shows methods and devices for inserting slot insulations into slots of a component of an electrical machine. A folding method for folding the slot insulation is also described and shown, which comprises the step of: providing a component of an electrical machine with at least one slot extending in the axial direction of the component, with conductors inserted into the slot to form a coil winding and with a slot insulation inserted into the slot between the slot and the conductors to electrically insulate the conductors from the region of the component forming the slot, wherein the slot insulation has a first leg and a second leg which are arranged between the conductors and slot flanks.

[4], [5] and [6] each show a slot cover slide and a slot cover slide mounting method. [7] shows another possible variant for inserting the slot insulations. [8] and [9] show a method and a device for slot cover slide mounting. [10] shows methods and devices for separating, aligning, and inserting slot cover slides for a stator. [3] and [11] to [13] show examples of manufacturing systems for components of electrical machines, using stators as an example, in which manufacturing systems embodiments of the invention can be used.

### SUMMARY OF THE INVENTION

The invention is based on addressing the problem of enabling improved folding of a slot insulation and/or insertion of slot cover slides in terms of process control and reliability in the context of large-scale series production of components for an electrical machine.

To solve this problem, the invention provides a folding method according to one or more embodiments. A slot cover slide mounting method, in which such a folding method is carried out, devices, apparatus, and systems for carrying out the folding method, as well as a control unit and a computer program with instructions for carrying out the folding or mounting method are the subject of one or more embodiments.

According to a first aspect, the invention provides a folding method for folding a slot insulation, wherein the folding method comprises the steps of:
a) providing a component of an electrical machine with at least one slot extending in the axial direction of the component, with conductors inserted into the slot to form a coil winding, and with a slot insulation inserted into the slot between the slot and the conductors to electrically insulate the conductors from the region of the component forming the slot, wherein the slot insulation has a first leg and a second leg which are arranged between the conductors and slot flanks, wherein at least one of the legs has a longitudinal edge region which protrudes radially over the conductors and projects out of the slot in at least one axial direction,
b) pre-positioning the part of the longitudinal edge region projecting axially out of the slot and protruding radially over the conductors by moving this part towards the center of the slot;
c) inserting a folding tool between the part of the longitudinal edge region moved in step b) in the direction of the center of the slot and the slot flank, and folding over the longitudinal edge region towards the conductors by means of the folding tool.

In some embodiments, step b) comprises
b) pre-positioning the part of the longitudinal edge region projecting axially out of the slot and protruding radially over the conductors by moving this part towards the center of the slot in order to create a gap between the longitudinal edge region and the slot flank at the axial end of the slot;
   and step c) comprises
c) inserting a folding tool into the gap formed in step b) and folding over the longitudinal edge region towards the conductors using the folding tool.

In some embodiments, in step a), the slot insulation is provided such that the longitudinal edge regions of the first and the second leg protrude over the conductors and project out of the slot in at least one axial direction.

In some embodiments, in step b), the corner regions of the first and the second leg, which project axially out of the slot and protrude radially over the conductors, are moved towards each other. In some embodiments, the gap is created at the axial end of the slot on both the first and the second leg.

In some embodiments, in step c), the longitudinal edge region of the first and the second leg is folded by means of one or more folding tools inserted into the respective gap.

In some embodiments, step a) includes the step:
a1) providing a stator component in which a plurality of slots are provided.

In some embodiments, step a) includes the step:
a2) providing a laminated core with a plurality of slots.

In some embodiments, step a) includes the step:
a3) providing an insulating paper or an insulating film as a slot insulation.

In some embodiments, step a) includes the step:
a4) providing the slot insulation with a U-shaped profile, with a U-web arranged on the base of the slot and the first leg arranged on a first flank of the slot and the second leg arranged on a second flank of the slot.

In some embodiments, step a) includes the step:
a5) providing the component with the slot in such a way that indentations or recesses are provided in a mouth region of the slot for the form-fitting reception of a slot cover slide.

In some embodiments, step b) includes the step:
b1) pressing the axially projecting part of the longitudinal edge region inward towards the center of the slot.

In some embodiments, step b) includes the step:
b2) providing a pre-positioning tool on the axial side of the component where the longitudinal edge region protrudes axially, and performing pre-positioning using the pre-positioning tool.

In some embodiments, step b), in particular step b2), includes the step:
b3) providing a pre-positioning tool with at least one presser movable in the circumferential direction.

In some embodiments, step b), in particular step b2), includes the step:
b4) providing a pre-positioning tool having a recess or a tool slot into which a folding tool and/or a slot cover slide to be inserted and/or a slot cover slide insertion tool for inserting a slot cover slide can engage.

In some embodiments, step b), in particular step b2), includes the step:
b5) providing a pre-positioning tool with a first and second presser which are movable in the circumferential direction towards and away from each other and with which the parts of the longitudinal edge regions of the first and the second leg which project axially out of the slot and protrude radially over the conductors are moved towards each other.

In some embodiments, step b) includes the step:
b6) pivoting at least one presser about a pivot axis during pre-positioning.

In some embodiments, step b), in particular step b2), includes the step:
b7) providing a pre-positioning tool having pressers that can be pivoted towards each other in the manner of pincers.

In some embodiments, step b) includes the step:
b8) parallel feeding of pressers during pre-positioning.

In some embodiments, step b) includes the step:
b9) pre-positioning by means of compressed air.

In some embodiments, the pre-positioning tool is actively driven by its own actuator. In some embodiments, the pre-positioning tool is passively driven during the insertion of a slot cover slide and/or by a slot cover slide insertion tool for inserting a slot cover slide. In some embodiments, pre-positioning is performed by means of a pre-positioning tool which has one or more nozzles for supplying compressed air. In some embodiments, the nozzles are set and positioned for pre-positioning. In some embodiments, the parts of the longitudinal edge region which project axially out of the slot and protrude radially over the conductors are blown with compressed air.

According to a further aspect, the invention provides a slot cover slide mounting method for mounting a slot cover slide in a slot provided with conductors and slot insulation of a component of an electrical machine, the method comprising carrying out the folding method according to one of the preceding embodiments and inserting the slot cover slide over the folded slot insulation in the slot.

According to a further aspect, the invention provides a folding device for folding a slot insulation which is inserted into a slot extending in the axial direction of a component of an electrical machine in order to electrically insulate conductors inserted into the slot to form a coil winding from the regions of the component forming the slot, wherein the slot insulation has a first leg and a second leg which are arranged between the conductors and slot flanks, wherein at least one of the legs has a longitudinal edge region protruding radially over the conductors and projecting out of the slot in at least one axial direction, wherein the folding device comprises a pre-positioning tool for pre-positioning the part of the longitudinal edge region which projects axially out of the slot and protrudes radially over the conductors, which pre-positioning tool is designed to move the part of the longitudinal edge region projecting axially out of the slot towards the center of the slot, and a folding tool which is designed to engage between the part of the longitudinal edge region moved towards the center of the slot by said pre-positioning operation at the axial beginning of the slot and the slot flank and to fold the longitudinal edge region towards the conductor along the entire run of the slot.

In some embodiments, the folding tool is designed to engage in a gap formed by the pre-positioning at the axial beginning of the slot between the longitudinal edge region and the slot flank and to fold the longitudinal edge region towards the conductors along the entire run of the slot.

In some embodiments, it is provided for the pre-positioning tool to be positioned axially laterally of the component during the use as intended.

In some embodiments, it is provided for the pre-positioning tool to have at least one presser for pressing the part of the longitudinal edge region projecting axially out of the slot towards the center of the slot.

In some embodiments, it is provided for the pre-positioning tool to have a first and a second presser that can be moved towards and away from each other in the circumferential direction.

In some embodiments it is provided for the pre-positioning tool to have at least one movable element for engaging at the axially protruding longitudinal edge region, which element is provided with at least one recess or at least one tool slot into which the folding tool or a slot cover slide mounting tool or a slot cover slide to be inserted into the slot can engage.

In some embodiments, it is provided for the at least one presser to be pivotable about a pivot axis.

In some embodiments, it is provided for the first and second pressers to be movable towards each other in the manner of pincers.

In some embodiments, it is provided for the at least one presser to be displaceable in the circumferential direction.

In some embodiments, it is provided for the first and the second presser to be displaceable in the circumferential direction in a manner antiparallel to each other.

In some embodiments, it is provided for the pre-positioning tool to have at least one nozzle which is designed to blow compressed air onto the part of the longitudinal edge region projecting axially out of the slot in order to move it towards the center of the slot.

According to a further aspect, the invention provides a slot cover slide mounting apparatus comprising a folding device according to one of the preceding embodiments and a slot cover slide insertion device for inserting a slot cover slide into the slot over the folded slot insulation.

According to a further aspect, the invention provides a manufacturing system for manufacturing a stator, the system comprising a folding device according to one of the preceding configurations and/or a slot cover slide mounting apparatus according to the preceding configuration.

According to a further aspect, the invention provides a computer-implemented control unit for a folding device, a slot cover slide mounting apparatus, or a manufacturing system according to one of the preceding configurations, wherein the control unit is designed to control the folding device to carry out the folding method according to one of the above-mentioned embodiments or to control the slot cover slide mounting apparatus to carry out the slot cover slide mounting method according to one of the above-described embodiments.

According to a further aspect, the invention provides a computer program comprising instructions that cause a device, apparatus or system according to one of the above configurations to carry out the method according to one of the above-described embodiments.

In some embodiments, the folding device, the slot cover slide mounting apparatus, or the manufacturing system comprise a control unit according to the above-mentioned configuration or a control unit comprising a processor and a memory in which a computer program according to the above-mentioned embodiment is loaded.

Some embodiments of the invention provide devices and methods for covering and/or securing coil winding parts received in slots of a component of an electric machine with the interposition of slot insulations with less effort, quickly, and reliably.

### BRIEF DESCRIPTION OF THE DRAWINGS

Embodiments of the invention are explained in more detail below with reference to the accompanying drawings. In the drawings:

FIG. 1 is a front view in the axial direction of a region of a component of an electrical machine, using the example of a stator, wherein, for the purpose of illustration, only one slot of a plurality of winding slots is shown in which several conductors of a coil winding of the component are accommodated with a slot insulation and a slot cover slide;

FIG. 2 is a view of the region of the component during a folding process for folding the slot insulation according to a comparative example using a folding device according to a comparative example;

FIG. 3 is a perspective view of the region of the component provided with the slot after a first step of a folding method according to an embodiment of the invention, in which the component having the slot, the slot insulation inserted therein, and the conductors received in the slot are provided;

FIG. 4 is a view as in FIG. 3, at the beginning of a second step of the folding method, in which pre-positioning of a region of the slot insulation takes place;

FIG. 5 is a view as in FIGS. 3 and 4, at the end of the second step;

FIG. 6 is an axial front view of the region shown in FIGS. 3 to 5, with the situation at the beginning of the pre-positioning in FIG. 4 being shown on the left and the situation at the end of the pre-positioning in FIG. 5 being shown on the right;

FIG. 7 is an axial front view of the region shown in FIGS. 3 to 6 at the beginning of a further step of the folding method following pre-positioning, wherein regions of the slot insulation are folded by means of a folding tool;

FIG. 8 is a partially sectional top view in the radial direction of the region at the start of the pre-positioning shown in FIG. 4, wherein a first embodiment of a pre-positioning tool for performing the step is shown schematically;

FIG. 9 is a view as in FIG. 6 on the right, wherein pre-positioning is shown by means of a second embodiment of the pre-positioning tool;

FIG. 10 is a view as in FIG. 4, wherein the step of pre-positioning is shown by means of a third embodiment of the pre-positioning tool;

FIG. 11 is a perspective view of the region of the component provided with the slot, after the second step of the folding method according to a further embodiment of the invention;

FIG. 12 is an axial front view of the situation shown in FIG. 11; and

FIG. 13 is an axial front view of the region of the component provided with the slot, during the third step of the folding method according to the further embodiment of the invention.

### DETAILED DESCRIPTION OF THE PREFERRED EMBODIMENTS

The invention relates to the field of manufacturing components of electrical machines having coil windings, such as rotors and stators, in particular to large-scale manufacturing of such components. Embodiments of the invention are described in the following using the example of the manufacture of a stator 10.

In some embodiments, the stator 10 has a laminated core 12 with a plurality of winding slots 14 that are distributed circumferentially on the laminated core 12 and serve to accommodate conductors 16 of a coil winding 18. For illustration purposes, only one of the winding slots 14, hereinafter simply referred to as slots 14, is shown in the accompanying drawings. The steps and features described below are provided analogously for the other slots 14.

In the example, the slot 14 (each slot 14) is an inwardly opening slot of an internal rotor motor. The methods, arrangements, and devices described below are also applicable in the same way to outwardly opening slots of an external rotor motor.

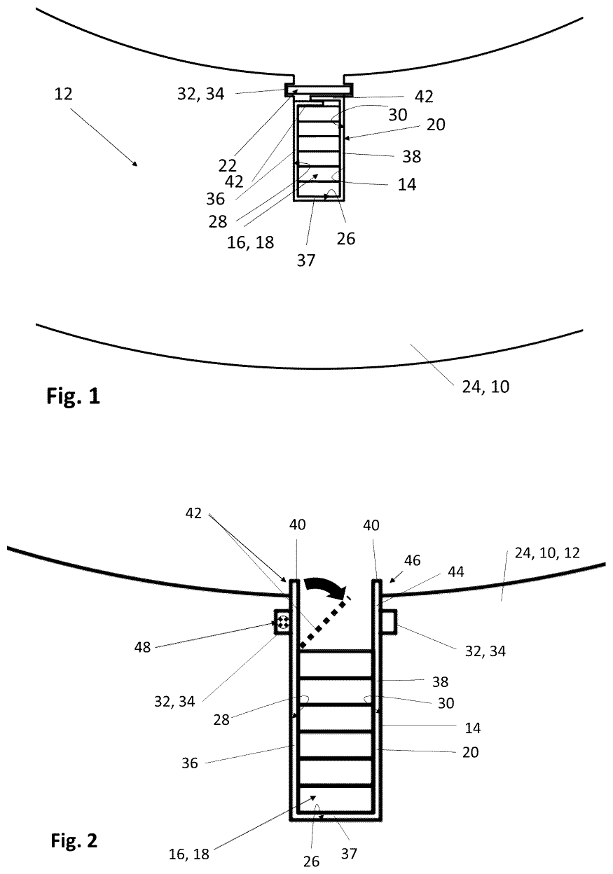

The stator 10 shown in FIG. 1, for example, can be provided with a coil winding 18 in a manufacturing system such as disclosed in one of the references [3] or [11] to [18]. In this case, the conductors 16 are inserted into the slots 14. A slot insulation 20 is inserted between the conductors 16 and the slot 14 receiving them, as is known, for example, from references [1] to [3] and [7] mentioned at the beginning.

As illustrated in FIG. 1, which shows the slot 14 with the conductors 16 and the slot insulation 20 in the finished stator 10, the conductors 16 can be covered with a slot cover slide 22.

The following describes preferred configurations of a folding method for folding the slot insulation 20, which method is explained, for example, before or during the installation of a slot cover slide for mounting the slot cover slide 22 in the slot 14 of a component 24 of an electric machine, with reference to the accompanying Figures. As mentioned, the component 24 of the electrical machine, which may in particular be a stator 10 or a rotor (not shown), has a coil winding 18. The coil winding 18 is formed, for example, with a coil mat or coil winding mat as known from references [14] to [18] and has the conductors 16, which are straight wire sections connected, for example, by winding heads. The conductors 16 are inserted into the slots 14 of the component 16 in the manner known from one of references [3], [6] or [18]. Furthermore, slot insulations 20 are provided which are inserted between the slot edges, i.e., in particular a slot base 26 and a first and a second slot flank 28, 30, and the conductors 16 inserted into the slots 14.

The slot cover slide 22 serves in particular to secure the conductors 15 inserted into the slots 14 against falling out. In some embodiments, the slot cover slides 22 can also be used to improve the behavior of the component in an impregnation process and/or the insulating behavior.

As shown in FIG. 1, the slot cover slide 22, which secures the conductors 16, e.g., wires, and the slot insulation 20 made, for example, of paper (insulating paper) or foil (insulating foil), can be inserted in a form-fitting manner into indentations or recesses 32 in the mouth region of the slot 14. For example, the mouth region of the slot 14 has a slot cover slide receiving groove 34 for receiving the slot cover slide 22. In some stator designs, the slot cover slide 22 can therefore be inserted into a slot cover slide receiving groove 34 in the laminated core 12.

In some embodiments, the slot insulation 22 (e.g. slot insulation paper) is folded into an “O” shape before the slot cover slide 22 is inserted.

FIG. 2 shows a folding method for performing such folding using a folding tool 48 according to a comparative example.

The slot insulations 20 are initially U-shaped, for example, in order to accommodate the conductors 16 in the radial direction when the coil winding 18 is inserted. Accordingly, the slot insulation 20 has a first leg 36 on the first slot flank 28 and a second leg 38 on the second slot flank 30. The end regions of the legs 36, 38, at which the longitudinal edges 40 of the slot insulation 20 are formed and which are referred to below as longitudinal edge regions 42, 44, are to be folded towards the conductors 16 by the folding method. In this case, a protrusion 46—a portion of the longitudinal edge region 42, 44 that protrudes from or over the winding slot 14, e.g., a protrusion of the paper over the inner diameter of the laminated core—can be very small or even negative (no protrusion), so that the slot insulation 20 can no longer be caught by a folding tool engaging at the inner diameter of the laminated core 12.

For this reason, in the comparative example shown in FIG. 2, the slot cover slide receiving groove 34 must therefore be used for the folding tool 48 in order to catch and fold the very stiff paper or similar material of the slot insulation 20. The slot cover slide receiving groove 34 in the laminated core 12 can be designed very small depending on the geometry of the slot cover slide 22 or, in some designs, is not present at all.

According to the comparative example shown in FIG. 2, a very small and delicate folding tool 48 must therefore dive into the slot cover slide receiving groove 34 behind the longitudinal edge region 42 and displace/fold the longitudinal edge region 42 inwards into the winding slot 14.

This small folding tool 48 is subject to great strains and must be positioned very precisely. It can be easily destroyed, which leads to machine downtime.

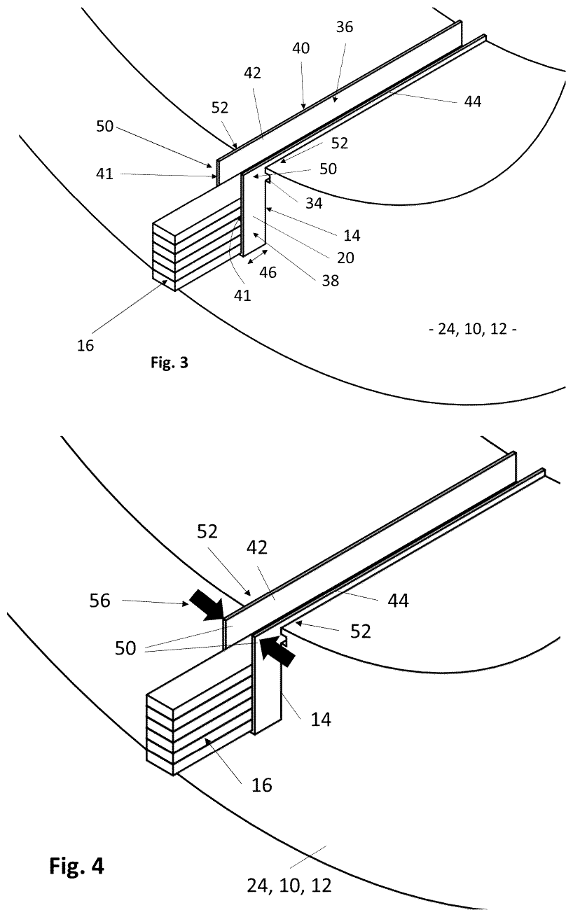

Some embodiments of folding methods and folding devices are explained in more detail below with reference to FIGS. 3 to 10, which methods are used to pre-position the regions 42, 44 of the slot insulation 20 to be folded so that the folding tools 48 can be made larger and sturdier.

The folding method for folding the slot insulation 20 initially comprises the step illustrated in the Figures:
a) providing the component 24 of an electric machine with at least one (winding) slot 14 extending in the axial direction of the component 24, with conductors 16 inserted into the slot 14 to form the coil winding 18, and with a slot insulation 20 inserted into the slot 14 between the slot 14 and the conductors 16, which is designed to electrically insulate the conductors 16 from the region 26, 28, 30 of the component 24 forming the slot 14, wherein the slot insulation 20 has a first leg 36 and a second leg 38 which are arranged between the conductors 16 and slot flanks 28, 30, wherein at least one of the legs 36, 38 has a longitudinal edge region 42, 44 protruding radially over the conductors and projecting out of the slot in at least one axial direction.

Step a) can be carried out in the manner known per se from the aforementioned references [1] to [3], [7] or [7] to [11] by inserting the slot insulations 20 and the conductors 16 into the slots 14 of the laminated core 12 of the stator 10, where, however, the slot insulations 20 are provided with an axial length that is greater than the axial extent of the slot (or of the laminated core 12) and are inserted with an axial protrusion so that a part 50 of at least one of the longitudinal edge regions 42, 44 protrudes axially over the slot 14. In some embodiments not shown, only the respective longitudinal edge region 42, 44 is longer; in the embodiments shown, the entire slot insulation 20 is longer than the slot 14, so that it projects axially out of the slot 14 as a whole. Thus, a portion 50 of each of the two longitudinal edge regions 42, 44 also projects axially out of the slot 14.

The slot insulation 20 is provided in particular with a U-shaped profile having a U-web 37 with the first leg 36 and with the second leg 38, so that the U-web 37 is arranged on the base 26 of the slot 14, the first leg 36 is arranged on the first flank 28 of the slot 14, and the second leg 38 is arranged on the second flank 30 of the slot 14.

As shown in FIG. 3, the slot insulation paper—example of slot insulation 20—then projects slightly out of the slots 14 at the end faces of the stator 10. In other words, there is an axial protrusion 46.

The folding method comprises the following further steps:
b) pre-positioning the part 50 of the longitudinal edge region 42, 44 which projects axially out of the slot 14 and protrudes radially over the conductors 16 by moving this part 50 towards the center of the slot 14—slot center—in order to create a gap 54 between the longitudinal edge region 42, 44 and the slot flank 28, 30 (only) at the axial slot end 52; and
c) inserting a folding tool 48 into the gap 54 formed in step b) and folding the longitudinal edge region 42, 44 towards the conductors 16 by means of the folding tool 48.

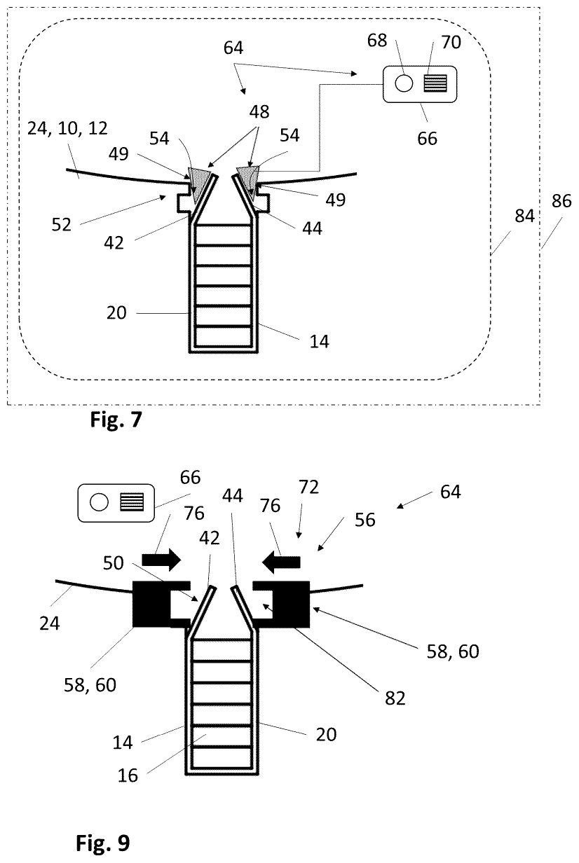

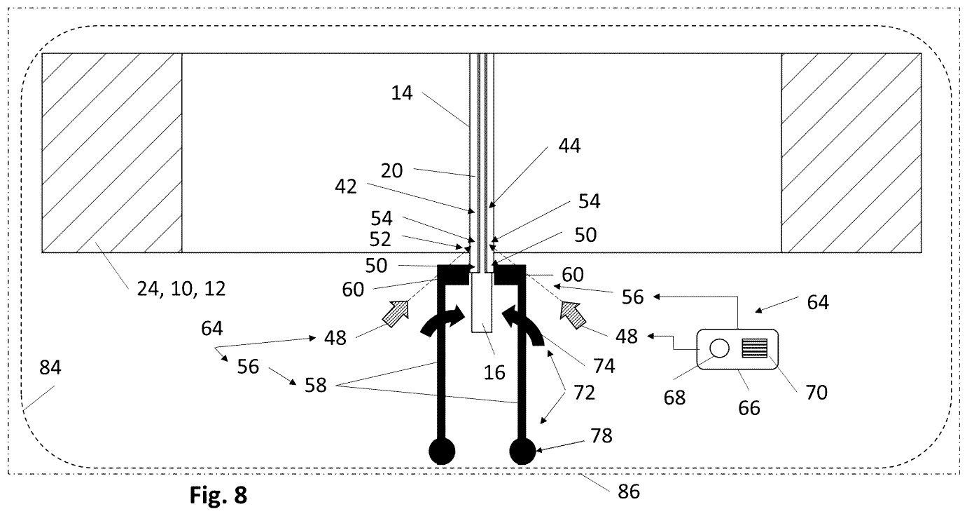

Step b) is illustrated in FIGS. 4 to 6. Step c) is shown in FIG. 7. Examples of a pre-positioning tool 56 for performing step b) are shown in FIGS. 8 to 10.

As can be seen in FIG. 4 and FIG. 6, left view, which indicate the beginning of step b), the pre-positioning tool 56 can engage at the axial protrusion, more precisely at the part 50 of the longitudinal edge regions 42, 44 which projects axially out of the slot 14 and protrudes radially over the conductor 16. In particular, the protruding part 50 is a corner region of the slot insulation 20 in the region of a corner formed by the longitudinal edge 40 and the end edge 41 of the respective leg 36, 38 extending in the radial direction. As shown in FIGS. 8 to 10, the pre-positioning tool 56 can, for example, have movable elements 58, e.g., with pressers 60 and/or with nozzles 62, which can be fed in the working position.

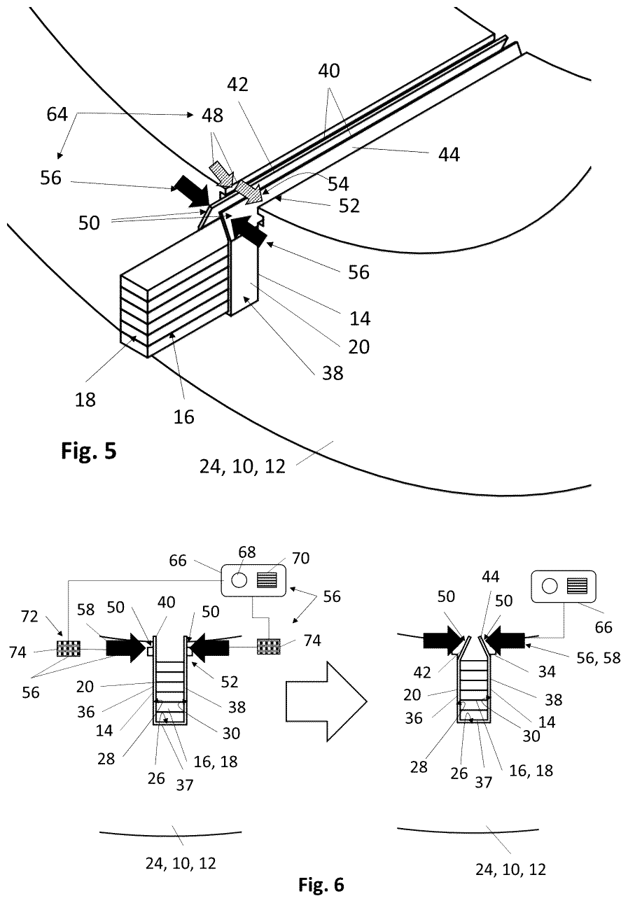

In the region of the end face of the component 24 (axially offset from the component 24, e.g., from a component holder not shown), there is sufficient space for the pre-positioning tool 56 and its movable elements 58. The pre-positioning tool presses, for example with pressers 60 and/or with compressed air 63, laterally against the axially projecting part of the longitudinal edge regions 42, 44 of the slot insulation and pushes it towards the center of the slot, as shown in FIG. 5 and FIG. 6 on the right. In this case, it is sufficient if only the (axial) beginning of the longitudinal edge region 42, 44 is positioned inwards.

This creates the gap 54 shown in FIG. 7 and an extended usable region.

Due to the significantly larger region that is open in the radial direction—e.g., radially inwards—the folding tool 48 can be designed to be more robust, and the positioning of the folding tool 48 does not have to be set as precisely. In addition, the radial protrusion of the leg 36, 38 of the slot insulation 20 into the inner diameter of the laminated core 12 is no longer relevant to the method, and the cover slide receiving groove 34 for guiding the slot cover slide 22 is also not required.

Some embodiments of a folding device 64 comprise—in addition to a component holder (not shown) for holding the component 24—the pre-positioning tool 56, the folding tool 48 and a computer-implemented control unit 66 with a processor 68 and memory 70 in which a computer program with control instructions for carrying out the folding method is stored.

The pre-positioning tool 56 is therefore designed as a separate component in addition to the actual folding tool 48. The folding tool 48 is only shown schematically, as its design may vary depending on the geometry. In some embodiments, the folding tool 48 is movable axially along the slot 14. In some embodiments, a first folding tool 48 is provided for folding the first longitudinal edge region 42, and a second folding tool is provided for folding the second longitudinal edge region. In other embodiments, a folding tool 48 with a first and second forming region is provided for forming the respective longitudinal edge regions 42, 44. The respective folding tool or the respective forming region has an insertion end 49 for insertion into the gap 54 formed at the beginning of the slot between the first longitudinal edge region 42 and the first slot flank 28 or for insertion into the gap 54 formed between the second longitudinal edge region 44 and the second slot flank 30. Starting from the insertion end 49, a curved folding surface is provided in a manner known per se, which, when the folding tool 48 is moved in the axial direction, causes the respective associated longitudinal edge region 42, 44 to be folded over and folded onto the conductors 16.

Some embodiments of the pre-positioning tool 56 are explained below with reference to FIGS. 8 to 10. In some embodiments, the pre-positioning tool 56 comprises a movement device 72 for moving the elements 58.

In the embodiments shown, when used as intended, the pre-positioning tool 56 is positioned axially laterally of the component 24.

In the embodiments shown, the pre-positioning tool 56 has a first and a second movable element 58. In the embodiments shown in FIGS. 8 and 9, each of the movable elements comprises a presser 60 for pressing the part 50 of the longitudinal edge region 42, 44 projecting axially out of the slot towards the center of the slot. Accordingly, a first and a second presser 60 movable towards and away from each other in the circumferential direction are provided.

In some embodiments, one example of which is shown in FIG. 9, the at least one movable element 58 of the pre-positioning tool 56, which serves to engage at the axially projecting longitudinal edge region, has at least one recess 80, for example in the form of at least one tool slot 82, into which the folding tool 48 or a slot cover slide mounting tool (not shown) or a slot cover slide 22 to be inserted into the slot can engage.

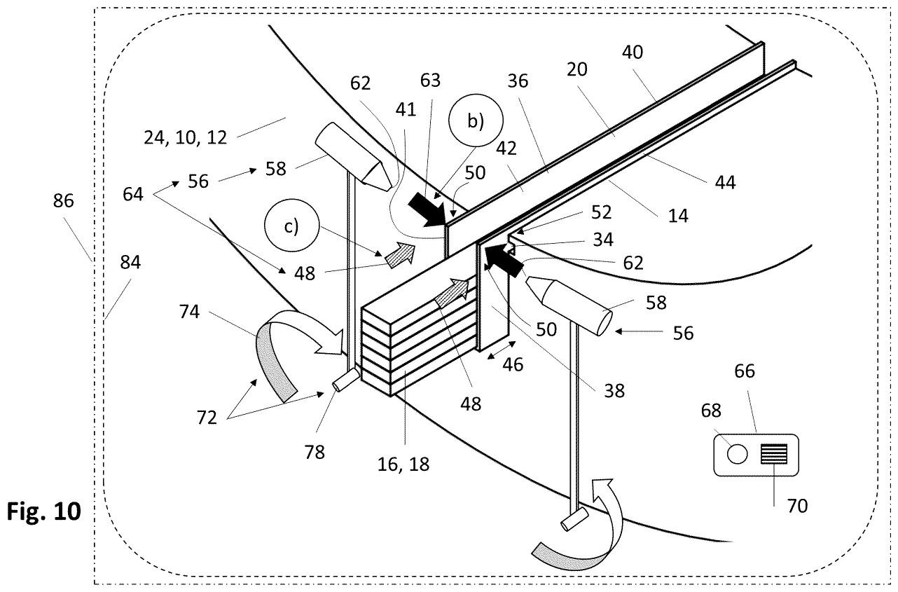

In some embodiments, one example of which is shown in FIG. 10, each movable element 58 has at least one nozzle 62, which is designed to blow compressed air 63 onto the part 50 of the longitudinal edge region 42, 44 which projects axially out of the slot in order to move it towards the slot center.

Different designs of the movement device 72 are possible. The movable elements 58 can be driven both actively and passively, e.g., by the stroke of the folding tool 48. Accordingly, in some embodiments, the movement device 72 has at least one actuator 74 that can be controlled by the control unit 68. In some embodiments, the movement device 72 has a gear (not shown) for converting a (working) movement of the folding tool 48 into a movement of the elements 58.

In some embodiments, one example of which is shown in FIG. 8, the elements 58 are pivotable about a pivot axis 78 of the movement device 72. For example, the pressers 60 are designed like needle-nose pliers and are provided with a fulcrum.

In some embodiments, one example of which is shown in FIG. 9, the elements 58 are displaceable in the circumferential direction. Accordingly, the movement device 72 has a guide 76 for the displacement movement of the elements 58. For example, the pressers 60 are positioned parallel to each other, in the manner of two jaw grippers.

As shown in FIG. 9, in some embodiments, the pressers 60 are provided with tool slots 82 so that the folding tools 48 can use even more air to catch the paper.

To mount the slot cover slide 22 in the slot 14 of the component 24 provided with the conductor 16 and the slot insulation 20, the folding method is first carried out in accordance with one of the above embodiments, whereupon the slot cover slide 22 is inserted over the folded slot insulation 20 in the slot 14.

A corresponding slot cover slide mounting apparatus 84, shown only schematically in block form in FIGS. 8 and 9, for carrying out the aforementioned slot cover slide mounting method accordingly comprises the folding device 64 according to one of the embodiments described above and a tool for inserting the slot cover slide 22. Such a tool is known to those skilled in the art, for example from references [4] to [6], so that it will not be explained in detail at this point. Reference is made to these documents for further details.

The folding device 64 is, for example, part of a manufacturing system 86 for a stator 10 which is also shown schematically in block form. The other system components of such manufacturing systems 86 are well known to those skilled in the art from the literature mentioned at the beginning.

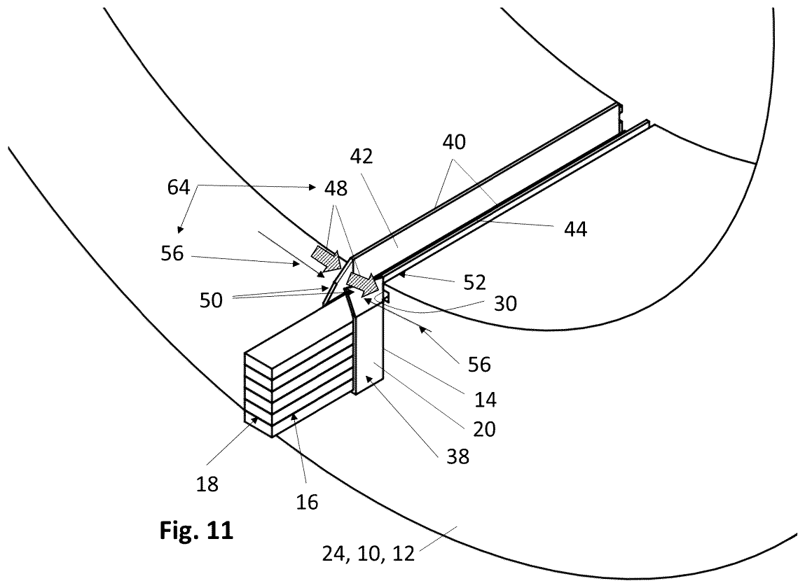

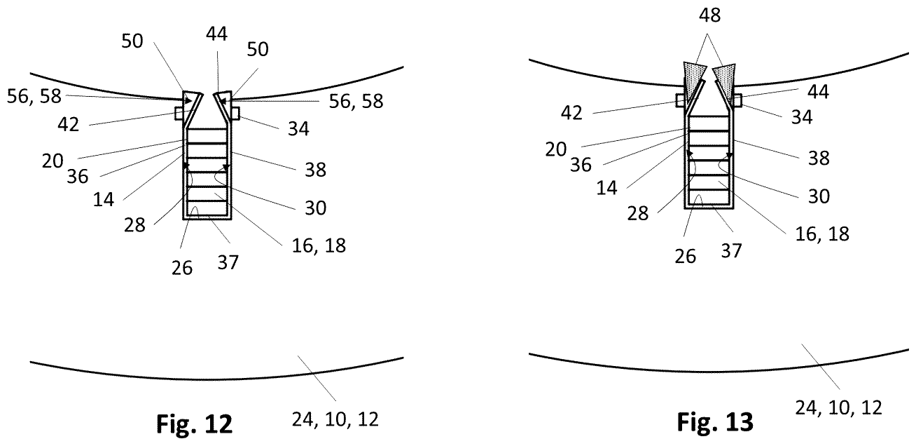

FIG. 11 shows a perspective view of the region of the component 24 provided with the slot after the second step b) of the folding method according to a further embodiment of the invention. FIG. 12 shows the same situation in an axial front view. FIG. 13 shows the axial front view as in FIG. 12 at the beginning of step c), where folding tools 48 are introduced for folding. As shown in FIGS. 11 to 13, it is not necessarily required to create the gap 54 during pre-positioning. In some embodiments, the slot insulation 20 is made of paper which has only a certain rigidity. Therefore, a gap does not necessarily have to form during pre-positioning. In the variant of step b)—pre-positioning—shown in FIGS. 11 and 12, only the outer paper ends—example for the part 50 (corner regions) of the longitudinal edge regions 42, 44 to be moved—are moved tangentially towards the slot center. The paper in the rear part of the slot can remain “open.” Nevertheless, the advantage remains, as the folding tool 48 can catch the paper in this way. As shown in FIG. 13, the folding tool 48 can be inserted between the part 50 of the longitudinal edge region 42, 44 moved towards the center of the slot and the slot flank 28, 30.

A folding method for folding a slot insulation (20) has been described, comprising the step: a) providing a component (24) of an electrical machine with at least one slot (14) extending in the axial direction of the component (24), with conductors (16) inserted into the slot (14) to form a coil winding (18), and with a slot insulation (20) inserted into the slot (14) between the slot (14) and the conductors (16) to electrically insulate the conductors (16) from the region of the component forming the slot, wherein the slot insulation (20) has a first leg (36) and a second leg (38). To improve the method in particular with regard to process control and reliability, it is proposed that step a) be carried out in such a way that, on at least one of the legs (36, 38), a longitudinal edge region (42, 44) protrudes radially over the conductor (16) and projects out of the slot (14) in at least one axial direction, and that the method further comprises the steps: b) pre-positioning the part (50) of the longitudinal edge region (42, 44) projecting axially out of the slot (14) and protruding radially over the conductors (16) by moving this part (50) in the direction of the slot center in order to create a gap (54) between the longitudinal edge region (42, 44) and the slot flank (28, 30), preferably at the axial slot end (52); and c) inserting a folding tool (48), preferably into the gap (54) formed in step b), and folding the longitudinal edge region (42, 44) towards the conductor (16) by means of the folding tool (48).

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 stator
12 laminated core
14 slot (winding slot for receiving conductors of a coil winding)
16 conductor
18 coil winding
20 slot insulation
22 slot cover slide
24 component
26 slot base
28 first slot flank
30 second slot flank
32 indentation/recess
34 slot cover slide receiving groove
36 first leg
37 U-shaped web
38 second leg
40 longitudinal edge
41 end edge
42 first longitudinal edge region
44 second longitudinal edge region
46 protrusion
48 folding tool
49 insertion end
50 part
52 axial slot end
54 gap
56 pre-positioning tool
58 element
60 presser
62 nozzle
63 compressed air
64 folding device
66 control unit
68 processor
70 memory
72 movement device
74 actuator
76 guide
78 pivot axis
80 recess
82 tool slot
84 slot cover slide mounting apparatus
86 manufacturing system

Claimed is:

1. A method for folding a slot insulation, comprising:
a) providing a component of an electrical machine with at least one slot extending in an axial direction of the component, with conductors inserted into the at least one slot to form a coil winding and with a slot insulation inserted into the at least one slot between the at least one slot and the conductors for electrically insulating the conductors from a region of the component forming the at least one slot, wherein the slot insulation has a first leg and a second leg which are arranged between the conductors and slot flanks, wherein in at least one of the first and second legs a longitudinal edge region protrudes radially over the conductors and projects out of the at least one slot in at least one axial direction;
b) pre-positioning a part of the longitudinal edge region projecting axially out of the at least one slot and protruding radially over the conductors by moving the part towards a center of the at least one slot; and,
c) inserting a folding tool between the part of the longitudinal edge region moved in step b) in a direction of the center of the at least one slot and a slot flank and folding the longitudinal edge region towards the conductor with the folding tool.

2. The method according to claim 1, wherein in step a), the slot insulation is provided in such a way that the longitudinal edge region of the first leg and the longitudinal edge region of the second leg protrude over the conductors and project out of the at least one slot in at least one axial direction, and in step b), corner regions of the first leg and the second leg projecting axially out of the at least one slot and protruding radially over the conductors are moved relative to one another, and in step c), the longitudinal edge region of the first leg and the second leg are folded over with one or more folding tools inserted between a respective corner region and a respective slot flank.

3. The method according to claim 1, wherein step a) comprises at least one or more of the following steps:
a1) providing a stator component in which a plurality of slots are provided;
a2) providing a laminated core with a plurality of slots;
a3) providing an insulating paper or an insulating film as the slot insulation;
a4) providing the slot insulation with a U-shaped profile, with a U-web arranged on a base of the at least one slot and the first leg arranged on a first flank of the at least one slot and the second leg arranged on a second flank of the at least one slot;
a5) providing the component having the at least one slot in such a way that indentations or recesses are provided in a mouth region of the at least one slot for the form-fitting reception of a slot cover slide.

4. The method according to claim 1, wherein step b) comprises at least one or more of the following steps:
b0) creating a gap at an axial slot end between the longitudinal edge region and a slot flank, into which the gap the folding tool is introduced in step c);
b1) pressing the axially protruding part of the longitudinal edge region inward towards the center of the at least one slot;
b2) providing a pre-positioning tool on the axial side of the component where the longitudinal edge region projects axially, and performing pre-positioning using the pre-positioning tool.

5. The method according to claim 1, wherein step b) includes at least one or more of the following steps:
b3) providing a pre-positioning tool with at least one presser movable in a circumferential direction;
b4) providing a pre-positioning tool with a recess or a tool slot into which a folding tool, a slot cover, or both slide to be inserted, or a slot cover slide insertion tool for inserting a slot cover slide is configured to engage, or both;
b5) providing a pre-positioning tool with a first presser and a second presser, which are configured to move in a circumferential direction towards each other and away from each other and with which parts of the longitudinal edge regions of the first and the second leg projecting axially out of the at least one slot and protruding radially over the conductors are moved towards each other;
b6) pivoting at least one presser about a pivot axis during pre-positioning;
b7) providing a pre-positioning tool with pressers configured to pivot towards each other;
b8) parallel feeding of pressers during pre-positioning; and
b9) pre-positioning using compressed air.

6. The method according to claim 5, wherein the pre-positioning tool is actively driven by an actuator of the pre-positioning tool or passively driven during an insertion of a slot cover slide, or by a slot cover slide insertion tool for inserting a slot cover slide, or both.

7. A method for mounting a slot cover slide in a slot of a component provided with conductors and a slot insulation of an electrical machine, comprising:
performing the method according to claim 1; and,
inserting the slot cover slide over the folded slot insulation in the at least one slot.

8. A device for folding a slot insulation inserted into a slot extending in an axial direction of a component of an electrical machine in order to electrically insulate conductors inserted into the slot to form a coil winding from a region of the component forming the slot, wherein the slot insulation has a first leg and a second leg which are arranged between the conductors and slot flanks, wherein in at least one of the first and second legs, a longitudinal edge region protrudes radially over the conductors and projects out of the slot in at least one axial direction, wherein the folding device comprises:
a pre-positioning tool for pre-positioning a part of the longitudinal edge region projecting axially out of the slot and protruding radially over the conductors, which pre-positioning tool is configured to move the part of the longitudinal edge region projecting axially out of the slot towards a center of the slot; and
a folding tool configured to engage between the part of the longitudinal edge region moved towards the center of the slot by the pre-positioning at an axial beginning of the slot and the slot flank and fold the longitudinal edge region along an entire run of the slot towards the conductors.

9. The device according to claim 8, wherein the pre-positioning tool is positioned axially laterally of the component during use, or
wherein the pre-positioning tool has at least one presser for pressing the part of the longitudinal edge region projecting axially out of the slot towards the center of the slot, or
wherein the pre-positioning tool has a first presser and a second presser configured to move towards each other and away from each other in a circumferential direction, or
wherein the pre-positioning tool has at least one movable element for engaging at an axially protruding longitudinal edge region, the at least one movable element having at least one recess or at least one tool slot into which the folding tool or a slot cover slide mounting tool or a slot cover slide to be inserted into the slot is configured to engage, or
wherein the pre-positioning tool has at least one nozzle configure to blow the part of the longitudinal edge region projecting axially out of the slot with compressed air through the at least one nozzle in order to move the at least one towards the center of the slot, or
any combination thereof.

10. The device according to claim 9, wherein the at least one presser is pivotable about a pivot axis, or
wherein the first presser and the second presser are configured to move towards each other, or
wherein the at least one presser is displaceable in the circumferential direction, or
wherein the first presser and the second presser are configured to be displaced in the circumferential direction in an antiparallel manner relative to each other.

11. A slot cover slide mounting apparatus comprising:
the device according to claim 8; and
a slot cover slide insertion device for inserting a slot cover slide over the folded slot insulation in the slot.

12. A manufacturing system for manufacturing a stator, comprising:
the slot cover slide mounting apparatus according to claim 11.

13. A non-transitory computer readable medium storing a computer program comprising instructions that when executed by a processor perform the method according to claim 1.

14. A control unit for a folding device comprising:
a processor; and,
the non-transitory computer readable medium according to claim 13.

15. A folding device comprising:
the control unit according to claim 14.
